(19) United States
(12) Patent Application Publication
(10) Pub. No.: US 2026/0285082 A1
(43) Pub. Date: Sep. 24, 2026

(54) A PANEL WITH 3D TEXTURE STRUCTURE, PREPARATION METHOD, AND APPLICATION

(71) Applicant: HANGZHOU PRINT FLOORING TECHNOLOGY CO., LTD., Hangzhou City (CN)

(72) Inventors: Guocui Yang, Hangzhou City (CN); Zhongshan Lei, Hangzhou City (CN); Mengde Deng, Hangzhou City (CN); Donghui Huang, Hangzhou City (CN); Fangbing Ao, Hangzhou City (CN); Feng Huang, Hangzhou City (CN)

(21) Appl. No.: 19/470,034

(22) PCT Filed: Mar. 1, 2024
(86) PCT No.: PCT/CN2024/079547

§ 371 Date: Sep. 27, 2025

(30) Foreign Application Priority Data
Mar. 31, 2023 (CN) 202310337404.9

(51) Int. Cl. B44C 5/04; B44C 3/02

(52) U.S. Cl. CPC B44C 5/043; B44C 3/025

(57) ABSTRACT

The present invention relates to the technical field of decorative panels, in particular to a panel with a 3D textured structure, its preparation method, and applications. The panel, from bottom to top, at least includes a substrate, a pattern layer, an abrasion-resistant layer, and a topcoat layer. The abrasion-resistant layer comprises a thickness-adjusting layer and a texture layer located above the thickness-adjusting layer. The texture layer includes a base portion and a three-dimensional portion, the three-dimensional portion being positioned above the base portion. The pattern layer contains multiple wood grain-shaped lines, which may be connected or disconnected. The three-dimensional portion comprises multiple wood grain-shaped grooves, which may be connected or disconnected, wherein at least some of the grooves correspond to the lines in one or more of arrangement position, length, or width. The top of at least part of the topcoat layer is lower than the upper surface of the three-dimensional portion. The panel of the present invention provides excellent wear resistance, while achieving better 3D texture clarity, improved tactile feel, and enhanced visual effect.

### TECHNICAL FIELD

The present invention pertains to the technical field of decorative boards, particularly relating to a board with a 3D texture structure, its preparation method, and application.

### BACKGROUND ART

In the decorative board industry, forming patterns with a 3D texture effect on the surface of a substrate is currently mainly achieved through the following two methods.

First, creating a raised three-dimensional effect by printing and stacking on a flat coating.

Related prior art, for example, CN109653465A discloses a PVC decorative board with a 3D effect and its 3D printing production method. The PVC decorative board includes a PVC board substrate, with a UV primer layer, a UV white paint layer, a pattern layer, a UV wear-resistant paint layer, a concave-convex effect layer, and a UV topcoat layer sequentially arranged from bottom to top. The UV white paint layer consists of 2 layers, the UV wear-resistant paint layer consists of 3 layers, and the UV topcoat layer consists of 2 layers. The concave-convex effect layer is formed by printing a concave-convex effect layer on the cured UV wear-resistant paint layer using a flatbed inkjet printer, where the concave-convex effect layer is UV transparent paint, and paint is stacked at specific pattern positions based on the pattern layer, thereby forming a concave-convex effect layer with a specific pattern.

The effect produced by this stacking method is relatively stiff, and since the edges of the formed wood grain are blunt, it is difficult to mimic the effect of real wood grain in terms of both visual and tactile aspects. The concave-convex effect layer formed by stacking, when used on flooring, results in poor foot comfort.

Second, creating a recessed texture effect by brushing and removing the corresponding texture parts on a flat coating.

Related prior art is introduced as follows.

CN112739463A discloses a method and apparatus for producing surface structures, including the following steps: A) applying resin A to the surface of a material; B) when resin A is in a liquid state or partially cured, applying liquid B to at least a portion of resin A; C) polymerizing resin A and liquid B separately; D) removing the polymerized liquid B to produce a three-dimensional structure.

This patent application discloses the principle of forming textures using a recessed method and analyzes the relevant physicochemical properties of liquid B as an embossing liquid and resin A to screen suitable liquid B. However, it does not specifically address the performance requirements of the final product with a three-dimensional structure.

CN110773403A discloses a 3D printed board with a surface brushing effect, where the board structure sequentially includes, from bottom to top, a base layer, a UV primer layer, a UV white paint layer, a UV transition paint layer, a color pattern layer, a UV wear-resistant paint, a 3D texture layer, and a UV topcoat layer. By using a flatbed inkjet printer to spray gloss oil on the uncured UV wear-resistant paint surface, the position of the gloss oil corresponds to the texture position of the color pattern layer; after printing, it is cured by the printer's built-in LED drying; at this point, the cured portion is limited to the area not covered by gloss oil, while the wear-resistant paint covered by gloss oil remains uncured; then, a wood grain brushing machine is used to perform brushing on the uncured printed parts in the 3D texture, resulting in the formation of the 3D texture layer.

In this patent application, gloss oil is printed on the uncured wear-resistant paint, and the gloss oil covers part of the wear-resistant paint, preventing it from curing in the subsequent curing process, allowing it to be removed to form grooves. Since the uncured areas covered by gloss oil are regular, the grooves formed in this way significantly differ from real wood grain in both visual effect and tactile feel. Moreover, as shown in FIG. 1 of this patent application, the surface of the formed board is flat and does not focus on the three-dimensional tactile feel.

In summary, although the second method produces a three-dimensional texture closer to real wood grain compared to the first method and has greater advantages, it is still in its preliminary stage and faces many unresolved issues. For example, the wear-resistant layer is in a semi-cured or uncured state, and brushing to form the texture layer on these wear-resistant layers damages the structure of the wear-resistant layer, reducing the board's wear resistance and even damaging the pattern of the pattern layer. Additionally, the formed 3D structure has poor three-dimensional effect, unnatural texture, and particularly poor clarity.

### SUMMARY OF THE INVENTION

To address the aforementioned defects in forming 3D textures on existing substrates, the present invention provides a board with a 3D texture structure.

The board with a 3D texture structure provided by the present invention improves the substrate for forming the 3D texture, achieving better 3D texture formation and visual effects while ensuring the board's wear resistance.

The solution adopted by the present invention is as follows:

A board with a 3D texture structure, comprising at least, from bottom to top, a substrate, a pattern layer, a wear-resistant layer, and a topcoat layer; the wear-resistant layer includes a thickness adjustment layer and a texture layer located above the thickness adjustment layer, the texture layer includes a base portion and a three-dimensional portion, the three-dimensional portion is located above the base portion, the pattern layer contains several connected or unconnected lines in the shape of wood grain, the three-dimensional portion includes several connected or unconnected grooves in the shape of wood grain, at least some of the grooves correspond to the lines in terms of one or more of arrangement position, length, or width, and the top of at least part of the topcoat layer is lower than the upper surface of the three-dimensional portion.

Currently, 3D digital printing boards are mostly in the theoretical research stage, and there are relatively few 3D digital printing boards in circulation on the market. Compared with 2D printing boards, it has been found that 3D digital printing boards have significantly insufficient clarity, blurred patterns, and weak tactile three-dimensionality. The inventors of the present invention analyzed these defects in an attempt to resolve them.

In the prior art, 3D digital printing boards form a three-dimensional structure on an uncured wear-resistant layer above the pattern layer. Since the pattern layer is not protected, it is easily damaged during the brushing process or in later use, resulting in poor wear resistance. For example, the 3D printing board disclosed in CN110773403A mentioned in the background technology forms brushed grooves on the uncured wear-resistant layer covered by gloss oil. Whether the brushing process damages the pattern on the pattern layer depends on the depth of the 3D texture. If a deeper 3D texture is required, penetrating the thickness of the wear-resistant layer, the issue of the pattern layer being damaged still persists.

Additionally, compared to 2D printing boards, 3D printing boards require the formation of a 3D texture, forming the 3D texture through the wear-resistant layer above the pattern layer and then coating multiple layers such as the topcoat layer, which leads to a decrease in the clarity of the pattern on the formed board.

Therefore, balancing wear resistance and pattern clarity is a current challenge for 3D digital printing boards.

To address the above challenges, most solutions focus on improving the composition of the wear-resistant paint or topcoat to achieve good wear resistance and transparency for the formed wear-resistant layer and topcoat layer. Some solutions improve the 2D ink used to form the pattern layer to enhance the bonding strength between the pattern layer and the substrate or primer layer.

The present invention breaks through conventional methods in this field, overcoming the prejudice that adding coatings reduces pattern clarity, and creatively sets the wear-resistant layer as a thickness adjustment layer and a texture layer. The thickness adjustment layer is formed by pre-curing before the texture layer is applied, and no groove structure is formed in the thickness adjustment layer. This thickness adjustment layer protects the pattern layer from being damaged during the groove formation process and provides excellent wear resistance, ensuring the board's wear-resistant effect against friction from external forces during use.

The texture layer in the present invention serves as the part forming the 3D texture structure, with grooves formed on it to create the three-dimensional portion of the texture layer. However, the grooves do not penetrate the texture layer, leaving a base portion below the three-dimensional portion where no grooves are formed. After setting the wear-resistant layer as a thickness adjustment layer and a texture layer, there is inevitably an issue of bonding strength. In actual use, it was found that the surface of the formed board is prone to peeling or delamination after a period of use. By setting a base portion in the texture layer, there is a certain distance (the thickness of the base portion) between the bottom of the grooves and the thickness adjustment layer, ensuring that the grooves do not penetrate the thickness direction of the texture layer, maintaining the integrity of the contact surface between the thickness adjustment layer and the texture layer, which is beneficial for ensuring the bonding strength between the thickness adjustment layer and the texture layer. Moreover, without the base portion, the thickness adjustment layer is easily scratched during the groove formation process, and the scratched parts affect the visual effect and clarity of the pattern. Therefore, compared to a wear-resistant layer without a base portion, the 3D texture formed by the present invention has better clarity and visual effect.

Furthermore, the inventors found that forming a cured thickness adjustment layer on the pattern layer before applying the wear-resistant layer for the 3D texture can appropriately increase the thickness of the three-dimensional portion of the texture layer without affecting pattern clarity, still achieving ideal clarity. Using a thicker three-dimensional portion can achieve deeper 3D textures, maintaining a noticeable concave-convex feel even after covering with a topcoat layer, resulting in a tactile feel closer to natural effects. For example, when the texture layer typically reaches about 100 g/m², the pattern appears blurry with poor clarity. After forming a cured thickness adjustment layer on the pattern layer, the texture layer can reach 150 g/m² or more while still maintaining relatively ideal clarity.

In the texture layer of the present invention, the clarity of the pattern is affected at different thicknesses. At this point, the clarity can be adjusted by adjusting the coating thickness of the thickness adjustment layer.

In some specific embodiments, the bottom and/or inner walls of the grooves have several protrusions. The protrusions can be regular or irregular. On one hand, the protrusions enhance the adhesion of the topcoat, improving the surface performance of the board. On the other hand, the presence of protrusions makes the tactile feel of the board more realistic.

In some specific embodiments, the number of protrusions on the bottom of at least some of the grooves exceeds the number of protrusions on the sidewalls, and/or the area of the protrusions on the bottom is greater than the area of the protrusions on the sidewalls.

In some specific embodiments, the protrusions account for at least 1%, or at least 5%, or at least 10%, or at least 15%, or at least 20%, or at least 25%, or at least 30%, or at least 35%, or at least 40%, or at least 45% of the total inner surface area of the grooves, but generally do not exceed 50%.

In some specific embodiments, the sidewalls of at least some of the grooves are connected to the bottom at an obtuse angle. Grooves with an obtuse angle connection provide a tactile feel closer to real wood grain and better comfort.

In some specific embodiments, the sidewalls have raised and/or recessed areas, enriching the tactile feel.

In some specific embodiments, the depth of the grooves ranges from 0.03 mm to 0.20 mm, more preferably from 0.08 mm to 0.20 mm.

In some specific embodiments, at least some of the grooves include a tactile deepening portion in the middle, visual simulation portions at both ends, and a transition portion between the tactile deepening portion and the visual simulation portion, with the width of at least some of the visual simulation portions being smaller than the width of the tactile deepening portion.

In some more preferred embodiments, the depth of the visual simulation portion of at least some of the grooves is smaller than the depth of the tactile deepening portion.

In the above technical solution, the grooves are divided into three parts, each serving different primary functions. The tactile deepening portion provides a more pronounced three-dimensional tactile feel; the visual simulation portion, in coordination with the tactile deepening portion, provides a tactile feel closer to real wood grain and enhances the visual effect, making the board appear more like real wood grain; the transition portion mainly serves to connect the former two parts. Controlling the depth and width of each part achieves the 3D texture effect of the board, making it closer to real wood grain in both visual and tactile aspects.

In some specific embodiments, the thickness of the thickness adjustment layer and the texture layer may be the same or different.

In other preferred embodiments, the thickness of the texture layer is greater than the thickness of the thickness adjustment layer. The thickness of the two parts is determined based on their functions, with the texture layer requiring greater thickness to form deeper grooves for a more pronounced 3D effect.

The wear-resistant layer is formed by coating with wear-resistant paint, which typically includes photosensitive resin, photoinitiator, and other additives. Other additives may include one or more combinations of curing agents, catalysts, cross-linking agents, leveling agents, antioxidants, defoamers, inorganic fillers, pigments, plasticizers, etc.

In some specific embodiments, the photosensitive resin is one or more combinations of epoxy resin, acrylic resin, acrylic-modified polyurethane resin, acrylic-modified silicone resin, acrylic-modified epoxy resin, etc.

In some specific embodiments, the material of the thickness adjustment layer and the texture layer may be the same or different.

In other embodiments, the material of the thickness adjustment layer is different from that of the texture layer. The thickness adjustment layer and the texture layer each serve different primary functions, and selecting materials based on their functional requirements is more conducive to the performance of different forms of wear-resistant layers.

In some specific embodiments, the coating amount of the wear-resistant paint used for the thickness adjustment layer is 35 g/m² to 55 g/m².

In some specific embodiments, the coating amount of the wear-resistant paint used for the texture layer is greater than or equal to 150 g/m².

In some specific embodiments, the texture layer is formed by two coatings with opposite coating directions, where the coating amount of the wear-resistant paint used for the first coating is greater than or equal to 75 g/m², and the coating amount of the wear-resistant paint used for the second coating is greater than or equal to 75 g/m².

The texture layer often requires greater thickness to form deeper grooves to highlight the tactile concave-convex feel. The inventors of the present invention found through testing that only when the total coating amount of the texture layer is greater than or equal to 150 g/m² can the formed texture achieve a feel similar to natural wood. When coating more than 150 g/m² at once, not only does the processing difficulty increase, but uneven roller coating also leads to uneven internal structure and thickness of the texture layer, affecting overall clarity. In this solution, the texture layer is formed by two coatings with opposite coating directions, so that during the second coating, a force opposite to the internal stress of the uncured second layer can be applied, reducing or offsetting the original internal stress in the texture layer, thus preventing cracking in the middle of the cured texture layer and overcoming the defect of poor clarity caused by internal cracking.

The substrate can be different types of board materials, including wood and wood-derived products, such as SPC stone-plastic boards. The material of the substrate is selected based on specific applications.

The thickness of the substrate layer can be determined based on specific applications. For example, in the case of decorative panels for furniture, it is typically between 5 mm and 25 mm, while for flooring production, the thickness is between 2 mm and 6 mm.

In some specific embodiments, the aforementioned board further includes a white film, formed on the substrate in any manner, such as using a commercially available PVC white film attached to the substrate to adjust the base color of the substrate and enhance the clarity of the printed pattern in the subsequent pattern layer.

In some specific embodiments, the aforementioned board further includes a primer layer coated on the white film to provide good adhesion for subsequent coatings.

In some specific embodiments, the aforementioned board further includes a color paint layer located between the primer layer and the pattern layer.

In some specific embodiments, the color paint layer is formed by roller or spray coating color paint on the cured primer and curing it. The color of the color paint depends on the requirements of the printed pattern, typically white, but other colors can be selected based on the needs of the printed pattern. This layer corrects the base color of the substrate on one hand and adjusts the polarity of the surface to be printed, improving the adhesion of the pattern layer on the other hand.

The curing of the primer layer, pattern layer, color paint layer, and wear-resistant layer can be photocuring, thermal curing, or electron beam curing. Photocuring includes, for example, UV lamps, mercury lamps, LED lamps, potassium lamps, etc. In particular, curing with LED lamps produces less light pollution.

In some specific embodiments, the pattern layer is formed by printing patterns using a multi-color ink digital printer on the primer layer and photocuring them, allowing for the printing of various patterns such as wood grain, stone grain, or personalized custom patterns.

The curing of the pattern layer can be photocuring, thermal curing, or electron beam curing. Photocuring includes, for example, UV lamps, mercury lamps, LED lamps, potassium lamps, etc. In particular, curing with LED lamps produces less light pollution.

In some specific embodiments, the pattern layer and the texture layer are formed by digital printing, and the digital printing ink can be UV ink, weak solvent ink, water-based ink, or oil-based ink.

The topcoat layer is formed by coating topcoat paint on the wear-resistant layer and curing it.

The topcoat layer can be one or multiple layers, mainly providing glossy or matte effects to the board and improving the surface gloss. The topcoat layer can also impart additional functions to the board, such as anti-fouling, anti-mold, antibacterial, waterproof, fireproof, anti-cracking, anti-slip, negative ion, formaldehyde removal, and wear-resistant functions.

The present invention also provides a preparation method for the aforementioned board with a 3D texture structure, including the following steps:
S1. Coating color paint on the substrate and curing it to form a color paint layer;
S2. Printing a wood grain pattern on the color paint layer to form a pattern layer;
S3. Coating wear-resistant paint on the pattern layer and curing it to form the thickness adjustment layer of the wear-resistant layer;
S4. Coating wear-resistant paint on the thickness adjustment layer of the wear-resistant layer without curing to form a texture layer;
S6. Applying embossing liquid to at least a portion of the surface of the texture layer;
S7. Curing the texture layer and removing the uncured or incompletely cured parts to form grooves on the texture layer;
S8. Coating topcoat paint on the surface obtained in S7 and curing it to form a topcoat layer, resulting in a board with a 3D texture structure.

In the above preparation method, the creative steps lie in steps S3 and S7.

In step S3 of the present invention, when forming the wear-resistant layer, the thickness adjustment layer is first coated and cured, meaning that the thickness adjustment layer undergoes a curing process before the texture layer is coated.

The board formed by this method has at least the following advantages:

Protection of the pattern layer: The thickness adjustment layer is cured before groove formation, and no groove structure is formed in the thickness adjustment layer. This layer protects the pattern layer from being damaged during the groove formation process.

Superior wear resistance: The thickness adjustment layer is a complete layer, providing excellent wear resistance, ensuring the board's wear-resistant effect against friction from external forces during use.

Higher clarity: This is an unexpected effect of the board produced by this method. Compared to a wear-resistant layer without a thickness adjustment layer, the 3D texture formed by the present invention has better clarity and visual effect. The reason may be that in the prior art, the texture layer is directly coated on the pattern layer, and the energy used to cure the wear-resistant paint typically comes from above the texture layer, causing the upper wear-resistant paint to cure first while the lower wear-resistant paint cures later. Since the wear-resistant paint undergoes a certain volume shrinkage during curing, internal stress is generated, which accumulates downward, reaching a maximum at the bottom of the resin liquid. If the wear-resistant paint is in direct contact with the pattern layer, once the maximum internal stress exceeds the bonding strength between the pattern layer and the layer below it, it causes slippage between the pattern layer and the board surface, leading to a mismatch between the bottom pattern layer and the grooves, resulting in visual blur and significantly reduced clarity. In the present invention, a thinner thickness adjustment layer is first formed on the pattern layer, and the internal stress generated after curing is weaker, avoiding excessive force on the pattern layer, thus ensuring the accuracy of the wood grain position in the pattern layer. On the other hand, in the prior art, directly coating the texture layer on the pattern layer, due to the discontinuous wood grain pattern in the pattern layer, affects the consistency of the wear-resistant paint's shrinkage during curing, leading to uneven internal shrinkage and fine grain marks after curing, which reduces clarity. In the present invention, the surface of the thickness adjustment layer is smooth, and when the wear-resistant paint of the texture layer cures on this surface, the shrinkage is consistent, avoiding fine grain marks inside the texture layer, resulting in good clarity.

Another role of the thickness adjustment layer is to improve the clarity of the board by adjusting its thickness. The texture layer, as the part forming the 3D texture structure, has grooves formed on it without affecting the board's wear resistance. Moreover, compared to a wear-resistant layer without a thickness adjustment layer, the 3D texture formed by the present invention has better clarity and visual effect.

Achieving deeper 3D textures: This method can also appropriately increase the thickness of the texture layer without affecting pattern clarity, still achieving ideal clarity. Using a thicker texture layer can achieve deeper 3D textures, maintaining a noticeable concave-convex feel even after covering with a topcoat layer, resulting in a tactile feel closer to natural effects.

In step S7 of the present invention, when forming the grooves of the texture layer, a base portion is reserved. The formation of the base portion is based on the difference between the thickness of the texture layer and the depth of the grooves. Reserving the base portion has at least the following advantages:

Enhanced bonding strength between the texture layer and the thickness adjustment layer: By setting a base portion in the texture layer, there is a certain distance (the thickness of the base portion) between the bottom of the grooves and the thickness adjustment layer, ensuring that the grooves do not penetrate the thickness direction of the texture layer, maintaining the integrity of the contact surface between the thickness adjustment layer and the texture layer, which is beneficial for ensuring the bonding strength between the thickness adjustment layer and the texture layer.

Improved clarity: Without the base portion, the thickness adjustment layer is easily scratched during the groove formation process, and the scratched parts affect the visual effect and clarity of the pattern. Therefore, compared to a wear-resistant layer without a base portion, the 3D texture formed by the present invention has better clarity and visual effect.

In the texture layer formed by the above method, the upper part has grooves as the three-dimensional portion, with a base portion reserved below the three-dimensional portion where no grooves are formed. The three-dimensional portion and the base portion are integrally connected, belonging to different parts of the texture layer.

In some specific embodiments, the coating amount of the wear-resistant paint used for the thickness adjustment layer is 35 g/m² to 55 g/m².

In some specific embodiments, the coating amount of the wear-resistant paint used for the texture layer is greater than or equal to 150 g/m².

In some specific embodiments, the base portion and the three-dimensional portion of the texture layer are formed by two coatings, with the coating amount of the wear-resistant paint used for the base portion being greater than or equal to 75 g/m², and the coating amount of the wear-resistant paint used for the three-dimensional portion being greater than or equal to 75 g/m².

In some specific embodiments, the coating direction for forming the base portion is opposite to the coating direction for forming the three-dimensional portion.

In some specific embodiments, in step S5, a steel brush is used to remove the uncured or incompletely cured parts. Using a steel brush for removal easily forms finer brushed textures, and the formed grooves have a shape closer to natural wood grain.

The present invention adopts a specific preparation method to form a specific board with a 3D texture structure. The pattern presented by this board has excellent clarity, and the presented 3D texture has superior three-dimensionality and tactile feel.

The present invention also provides applications of the aforementioned board or the board obtained by the aforementioned preparation method, specifically in flooring, wall panels, or ceiling panels.

In summary, the present invention has the following advantages:
1. The present invention sets the wear-resistant layer as a thickness adjustment layer and a texture layer, with no groove structure formed in the thickness adjustment layer. This layer protects the pattern layer from being damaged during the groove formation process and provides excellent wear resistance, ensuring the board's wear-resistant effect against friction from external forces during use. The texture layer, as the part forming the 3D texture structure, has grooves formed on it without affecting the board's wear resistance. Moreover, compared to a wear-resistant layer without a thickness adjustment layer, the 3D texture formed by the present invention has better clarity and visual effect.
2. The thickness adjustment layer in the present invention can also be used to adjust the clarity of the board. By varying the thickness of the thickness adjustment layer based on the thickness of the texture layer and the depth of the grooves, the clarity of the board can be adjusted.
3. The present invention, using a wear-resistant layer with a thickness adjustment layer, can appropriately increase the thickness of the texture layer without affecting pattern clarity, still achieving ideal clarity. Using a thicker texture layer can achieve deeper 3D textures, maintaining a noticeable concave-convex feel even after covering with a topcoat layer, resulting in a tactile feel closer to natural effects.
4. The present invention can also utilize grooves to increase the bonding strength between layers, ensuring the overall performance of the board.

### BRIEF DESCRIPTION OF THE DRAWINGS

FIG. 1 is a schematic diagram of the layered structure of the board provided in Embodiment 1 of this specification;

FIG. 2 is a schematic diagram of the partial three-dimensional structure of the board provided in Embodiment 1 of this specification;

FIG. 3 is an enlarged schematic diagram of a partial groove of the board provided in Embodiment 1 of this specification;

FIG. 4 is a schematic diagram of the partial three-dimensional structure of the board provided in Comparative Example 1 of this specification;

FIG. 5 is a top view of the board provided in Comparative Example 1 of this specification;

FIG. 6 is an enlarged schematic diagram of a partial groove of the board provided in Comparative Example 4 of this specification.

### DETAILED DESCRIPTION OF THE INVENTION

The technical solution of the present invention will be described in detail below in conjunction with specific embodiments.

### EMBODIMENT

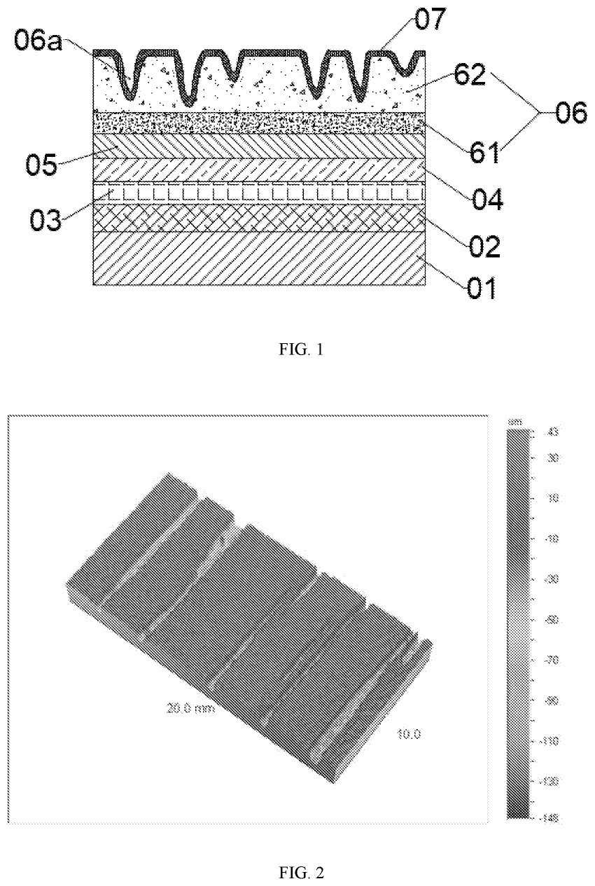

A board with a 3D texture structure, as shown in FIG. 1, includes, from bottom to top, a substrate 01, a white film 02, a primer layer 03, a color paint layer 04, a pattern layer 05, a wear-resistant layer 06, and a topcoat layer 07.

In this embodiment, SPC stone-plastic wood is used as the substrate, with a thickness of 4 mm. The white film is a commercially available PVC white film, attached online to the substrate after extrusion.

The primer layer is formed by roller coating a transparent acrylic varnish on the white film and curing it with a UV lamp.

The color paint is white paint, roller coated on the primer layer and cured with a UV lamp.

The pattern layer is formed by printing patterns using a multi-color ink digital printer and photocuring, with a wood grain pattern printed in this embodiment, the pattern layer having several connected or unconnected lines in the shape of wood grain.

The wear-resistant layer includes two layers: a thickness adjustment layer above the pattern layer and a texture layer above the thickness adjustment layer. The thickness adjustment layer is formed by coating transparent wear-resistant paint on the pattern layer and photocuring it. The curing step is completed before coating the texture layer.

The texture layer of the wear-resistant layer is formed by coating transparent wear-resistant paint on the thickness adjustment layer, with several connected or unconnected grooves 06a in the shape of wood grain formed on the texture layer. The width, depth, and length of different grooves may vary, and the width, depth, and length of the grooves are related to the pattern of the pattern layer, with the grooves corresponding to the lines of the pattern layer in terms of arrangement position, length, or width, ensuring accurate alignment.

The texture layer is formed by coating wear-resistant paint on the thickness adjustment layer, with grooves formed on the texture layer. The maximum depth of the grooves is less than the thickness of the texture layer, and the unpenetrated bottom of the texture layer is the base portion, with the three-dimensional portion having grooves above the base portion.

The topcoat layer is formed by coating topcoat paint on the surface of the three-dimensional portion of the wear-resistant layer, with the top of the topcoat layer in the areas corresponding to the grooves being lower than the upper surface of the three-dimensional portion outside the grooves.

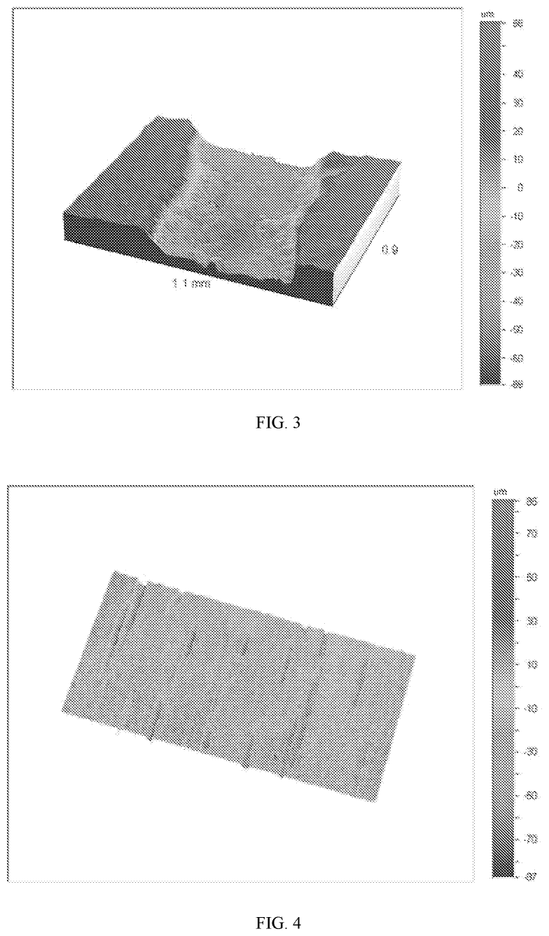

The board of this embodiment was analyzed using a laser profilometer, with results shown in FIGS. 2 and 3.

As can be clearly seen from FIG. 2, the surface of the board provided in this embodiment has a distinct concave-convex structure due to the grooves, with a noticeable concave-convex tactile feel.

As shown in FIG. 3, some of the grooves have raised and recessed areas on their sidewalls. Both the bottom and sidewalls of the grooves have irregular protrusions 06b. The number of protrusions at the bottom of the grooves is significantly greater than the number of protrusions on the sidewalls. The area of the protrusions accounts for approximately 10% of the total inner surface area of the grooves. The number of protrusions can be adjusted at least by the diameter and distribution density of the steel wires on the steel roller of the brushing machine. For example, reducing the diameter of the steel wires and increasing their density reduces the number and area proportion of the protrusions.

From the structure of a single groove, some of the grooves consist of three parts: a tactile deepening portion in the middle, visual simulation portions at both ends, and a transition portion between the tactile deepening portion and the visual simulation portion. The tactile deepening portion is the deepest area, with some grooves reaching 0.2 mm. For some grooves, the width of the visual simulation portion at both ends is smaller than the width of the tactile deepening portion, while for others, the width of the visual simulation portion at one end is smaller than the width of the tactile deepening portion, and the width of the visual simulation portion at the other end is comparable to the width of the tactile deepening portion. Grooves with this special structure produce a wood grain texture that is closer to real wood grain in terms of visual effect and tactile feel.

### EMBODIMENT

This embodiment specifically describes the preparation method of the board with a 3D texture structure in Embodiment 1, including the following steps:
(S.1) Place an SPC board with a white film, with dimensions of 1260 mm×970 mm×4.85 mm, on the surface of a conveyor moving in a fixed direction;
(S.2) During the conveying process, the SPC board first passes through a first roller coater, with the coating roller surface attached with photocurable primer (primer composition: 90% photocurable varnish HYS01-1, 5% photoinitiator 184, 0.5% photoinitiator TPO, 4.5% diluent hydroxyethyl acrylate). During contact between the SPC board and the coating roller, 12 g/m² of primer is coated on the surface of the SPC board, cured with a 395 nm and 8 W/cm² UV lamp to form the primer layer;
(S.3) The SPC board obtained in the previous step is passed through a second roller coater, with the coating roller surface attached with photocurable white paint (white paint composition: 50% photocurable epoxy HYS01-1, 30% titanium dioxide, 5% photoinitiator 184, 0.5% photoinitiator TPO, 14.5% diluent hydroxyethyl acrylate). During contact between the SPC board and the coating roller, 18 g/m² of white paint is coated on the surface of the primer, cured with a 395 nm and 8 W/cm² UV lamp to form a white color paint layer;
(S.4) The SPC board obtained in the previous step is conveyed to a first inkjet printer, where 6-8 g/m² of ink is sprayed on the surface of the color paint layer using the first inkjet printer, and the ink is cured to form a pattern layer with a wood grain pattern on the surface of the primer layer;
(S.5) The SPC board obtained in the previous step is conveyed to a third roller coater, where 45 g/m² of photocurable resin liquid (resin liquid composition: 90% Dow Corning 65 Additive, 5% photoinitiator 184, 0.5% photoinitiator TPO, 4.5% diluent hydroxyethyl acrylate) is roller coated on the surface of the pattern layer, sequentially irradiated with a 395 nm and 8 W/cm² UV lamp and a 160 W/cm² Hg lamp to cure, forming the thickness adjustment layer;
(S.6) The SPC board obtained in the previous step is conveyed to a fourth roller coater, where the coating roller of the fourth roller coater, along the conveying direction of the SPC board (the roller itself rotates clockwise), roller coats 80 g/m² of resin liquid (resin liquid composition: 90% Dow Corning 65 Additive, 5% photoinitiator 184, 0.5% photoinitiator TPO, 4.5% diluent hydroxyethyl acrylate) to form the base portion of the texture layer;
(S.7) After coating the first layer of resin liquid, the SPC board is conveyed forward along the surface of the conveyor, ensuring that the fourth roller coater does not apply any force to the resin liquid before it is conveyed to the next roller coater;
(S.8) The SPC board obtained in the previous step is conveyed to a fifth roller coater, where the coating roller of the fifth roller coater, against the conveying direction of the SPC board (the roller itself rotates clockwise), continues to roller coat 75 g/m² of resin liquid (the resin liquid is the same as in step (S.6)) to form the three-dimensional portion of the texture layer;
(S.9) The SPC board obtained in the previous step is conveyed to a second inkjet printer, where 8 g/m² of embossing liquid (embossing liquid composition: 45.5% diacrylate monomer PEG600DA, 20.5% hydroquinone monomethyl ether HQMME, 10% 2-tert-butyl hydroquinone MTBHQ, 24% diethylene glycol butyl ether) is sprayed on the surface of the resin liquid, allowing the embossing liquid to penetrate downward into the resin liquid and mix with it;
(S.10) The SPC board obtained in the previous step is sequentially irradiated with a 395 nm and 8 W/cm² UV lamp and a 160 W/cm² Hg lamp for deep curing;
(S.11) The SPC board obtained in the previous step is conveyed to a cleaning device containing a steel brush (steel wire diameter 0.02 mm), where the mixed portion of the embossing liquid and resin liquid is brushed off by the steel brush, forming grooves in these areas;
(S.12) The SPC board obtained in the previous step is coated with 12 g/m² of topcoat paint using a sixth roller coater and cured with a 395 nm and 8 W/cm² UV lamp to form the topcoat layer.

### Comparative Example 1

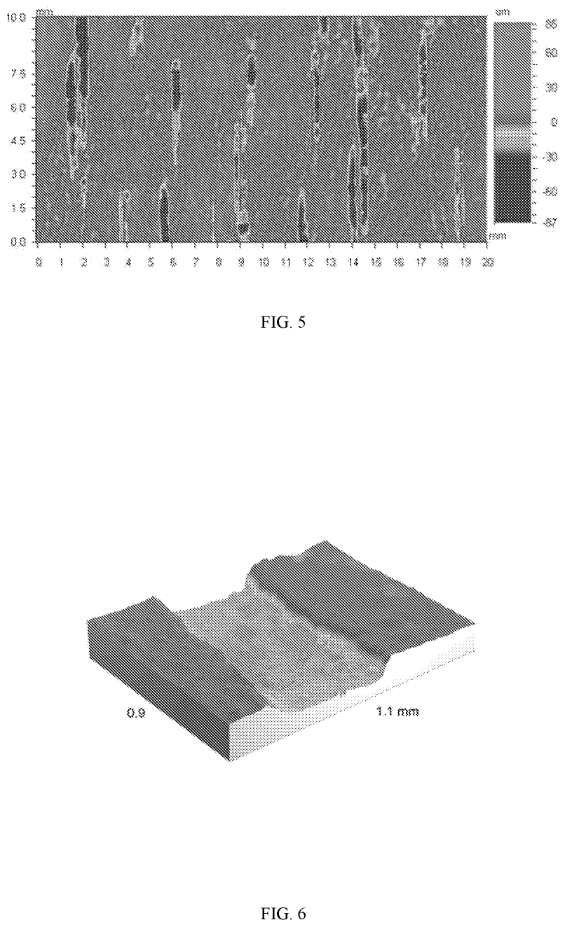

The steps are essentially the same as those in Embodiment 2, except that step (S.5) is omitted in Comparative Example 1, so the resulting board does not include a thickness adjustment layer. FIGS. 4 and 5 are schematic diagrams of the three-dimensional structure and top view of the board prepared in Comparative Example 1 of this disclosure, respectively. It can be seen from the figures that after omitting step (S.5), the average depth of the formed wood grain is smaller, and the surface texture of the board significantly differs from real wood grain in both visual and tactile aspects.

### Comparative Example 2

The steps are essentially the same as those in Embodiment 2, except that in step (S.5) of this comparative example, no curing treatment is performed after roller coating the wear-resistant paint. Compared to the board obtained in Embodiment 2, the board obtained in this comparative example has comparable wood grain depth but significantly lower clarity and wear resistance.

### Comparative Example 3

The steps are essentially the same as those in Embodiment 2, except that after step (S.8), the wear-resistant paint is irradiated with UV light, resulting in an incompletely cured texture layer. The average depth of the formed wood grain is lower, and clarity decreases.

### Comparative Example 4

The steps are essentially the same as those in Embodiment 2, except that in step (S.9), the amount of embossing liquid applied is 15 g/m². The maximum depth of the formed grooves is slightly greater than the thickness of the texture layer, penetrating the texture layer at the deepest point. The clarity of the resulting board decreases.

### EMBODIMENT

The steps are essentially the same as those in Embodiment 2, except for steps (S.6) to (S.8). In this embodiment, steps (S.6) to (S.8) are combined into one step (S.6) as follows:
(S.6) The SPC board obtained in the previous step is conveyed to a fourth roller coater, where the coating roller of the fourth roller coater, along the conveying direction of the SPC board, roller coats 155 g/m² of resin liquid (resin liquid composition: 90% Dow Corning 65 Additive, 5% photoinitiator 184, 0.5% photoinitiator TPO, 4.5% diluent hydroxyethyl acrylate) to form the texture layer.

### Embodiment 4

The steps are essentially the same as those in Embodiment 2, except for step (S.8), where the coating directions of the two coatings are the same. Steps (S.6) to (S.8) in this embodiment are as follows:
(S.6) The SPC board obtained in the previous step is conveyed to a fourth roller coater, where the coating roller of the fourth roller coater, along the conveying direction of the SPC board (the roller itself rotates clockwise), roller coats 80 g/m² of resin liquid (resin liquid composition: 90% Dow Corning 65 Additive, 5% photoinitiator 184, 0.5% photoinitiator TPO, 4.5% diluent hydroxyethyl acrylate) to form the base portion of the texture layer;
(S.7) After coating the first layer of resin liquid, the SPC board is conveyed forward along the surface of the conveyor, ensuring that the fourth roller coater does not apply any force to the resin liquid before it is conveyed to the next roller coater;
(S.8) The SPC board obtained in the previous step is conveyed to a fifth roller coater, where the coating roller of the fifth roller coater, along the conveying direction of the SPC board (the roller itself rotates clockwise), continues to roller coat 75 g/m² of resin liquid (the resin liquid is the same as in step (S.6)) to form the three-dimensional portion of the texture layer.

### Product Testing:

Surface wear resistance test: Conducted according to standard GT/T 18102-2020.
Surface scratch resistance test: Conducted according to standard GT/T 18102-2020.
Clarity test: Conducted according to standard JIS K7374.
Tactile depth level test.
Tactile feel closeness to real wood grain test.

### Tactile Depth Level Test Method and Standard:

Organize 15 evaluators to evaluate the tactile depth of the board to be tested. They touch the surface of the board, feel the concave-convex sensation and the depth of the grooves, and record the evaluation results by level, with the level selected by the majority as the final evaluation level of the board.

Tactile depth is divided into five levels, with the five levels and evaluation criteria as shown in Table 1.

TABLE 1
Tactile Depth Levels and Criteria

| Level | Criteria |
|---|---|
| Level 1 | The board has a very pronounced concave-convex feel, |
| | and grooves can be felt with light touch, |
| | with very deep grooves. |
| Level 2 | The board has a relatively pronounced concave-convex |
| | feel, with relatively deep grooves. |
| Level 3 | The board has a concave-convex feel, with deep grooves, |
| | but the tactile feel is less pronounced than Level 2. |
| Level 4 | The board has some concave-convex feel, requiring some |
| | force to feel the grooves, with shallow grooves. |
| Level 5 | The board has almost no concave-convex feel, |
| | with very shallow grooves |

Note:
From Level 1 to Level 5, the concave-convex feel gradually decreases, and the grooves become progressively shallower.

Tactile feel closeness to real wood grain test method and standard:

Organize 15 evaluators to test the tactile feel closeness to real wood grain. They first touch the wood grain of a piece of real wood, then touch the surface of the board to be tested, evaluate the degree of closeness, and record the evaluation results by level, with the level selected by the majority as the final evaluation level of the board.

Tactile feel closeness to real wood grain is divided into four levels, with the five levels and evaluation criteria as shown in Table 2.

TABLE 2
Tactile Feel Closeness to Real Wood Grain Levels and Criteria

| Level | Criteria |
|---|---|
| Level I | The tactile feel is very close |
| | to real wood grain. |
| Level II | The tactile feel is relatively |
| | close to real wood grain. |
| Level III | The tactile feel differs from |
| | real wood grain. |
| Level IV | The tactile feel significantly |
| | differs from real wood grain |

The surface wear resistance, scratch resistance, and clarity performance test results of the boards in Embodiments 2-4 and Comparative Examples 1~4 are shown in Table 3 below:

TABLE 3
Performance Test Results

| | Embodiment | Comparative | Comparative | Comparative | Comparative | Embodiment | Embodiment |
|---|---|---|---|---|---|---|---|
| Item | 2 | Example 1 | Example 2 | Example 3 | Example 4 | 3 | 4 |
| Surface | ≥6000 | ≥4500 | ≥6000 | ≥6000 | ≥6000 | ≥6000 | ≥6000 |
| Wear | revolutions | revolutions | revolutions | revolutions | revolutions | revolutions | revolutions |
| Resistance | | | | | | | |
| Surface | ≥4.0N | 2~3N | ≥4.0N | ≥4.0N | ≥4.0N | ≥4.0N | ≥4.0N |
| Scratch | | | | | | | |
| Resistance | | | | | | | |
| Clarity | 84.2% | 59.5% | 66.5% | 71.8% | 61.6% | 76.2% | 80.1% |

Result Analysis: Compared to Embodiment 2, Comparative Example 1 does not include a thickness adjustment layer, resulting in significantly reduced wear resistance and partial damage to the pattern layer, with a significant decrease in clarity.

Compared to Embodiment 2, Comparative Example 2 directly coats the texture layer without curing the thickness adjustment layer, resulting in a board structure with significantly lower clarity.

Compared to Embodiment 2, Comparative Example 3 applies embossing liquid after incomplete curing of the texture layer with UV light, which is not conducive to the penetration of the embossing liquid, resulting in lower wood grain depth, poorer three-dimensional texture effect, and reduced clarity due to poor matching between the formed grooves and the wood grain pattern of the pattern layer.

Compared to Embodiment 2, Comparative Example 4 does not reserve a base portion in the texture layer, resulting in a certain degree of impact on the clarity of the board.

Compared to Embodiment 2, Embodiment 3 forms the texture layer with a single coating, which causes uneven distribution of the wear-resistant paint inside the texture layer during the coating process, affecting clarity to some extent.

Compared to Embodiment 2, Embodiment 4 forms the texture layer with two coatings in the same direction, which affects clarity compared to the opposite-direction coating method.

The tactile depth level and tactile feel closeness to real wood grain test results for the boards in Embodiments 2-4 and Comparative Examples 1~4 are shown in Table 4 below:

TABLE 4
Performance Test Results

| | Embodiment | Comparative | Comparative | Comparative | Comparative | Embodiment | Embodiment |
|---|---|---|---|---|---|---|---|
| Item | 2 | Example 1 | Example 2 | Example 3 | Example 4 | 3 | 4 |
| Tactile | Level 1 | Level 3 | Level 1 | Level 2 | Level 1 | Level 1 | Level 1 |
| Depth | | | | | | | |
| Level | | | | | | | |
| Tactile | Level I | Level III | Level II | Level II | Level II | Level II | Level II |
| Feel | | | | | | | |
| Closeness | | | | | | | |
| to | | | | | | | |
| Real | | | | | | | |
| Wood | | | | | | | |
| Grain | | | | | | | |

### Embodiment 5

Different from Embodiment 2, in step (S.11), a steel brush with thicker wires (diameter approximately 0.05 mm) is used to brush off the mixed portion of the embossing liquid and resin liquid, forming grooves with more protrusions on the surface; the protrusions account for approximately 30% of the total inner surface area of the grooves.

### Comparative Example 5

Different from Embodiment 2, in step (S.11), a fine brush (bristle diameter approximately 0.01 mm) is used to brush off the mixed portion of the embossing liquid and resin liquid, forming grooves on the surface. The grooves formed in this way have almost no noticeable protrusions, as shown in the laser profilometer analysis in FIG. 6.

The relevant performance test results for the boards in Embodiment 5 and Comparative Example 5 are shown in Table 5 below:

TABLE 5
Performance Test Results

| | | Comparative |
|---|---|---|
| Item | Embodiment 5 | Example 5 |
| Surface Wear Resistance | ≥6000 revolutions | ≥6000 revolutions |
| Surface Scratch Resistance | ≥4.0N | ≥4.0N |
| Clarity | 86.9% | 75.2% |
| Tactile Depth Level | Level 1 | Level 1 |
| Tactile Feel Closeness to | Level I | Level III |
| Real Wood Grain | | |

As can be seen from Table 5, the clarity of the board in Comparative Example 5 is lower than that of Embodiment 5. Furthermore, by touching the surfaces of the boards in Embodiment 5 and Comparative Example 5, the tactile feel of Embodiment 5 is closer to real wood grain, and visually it is also closer to real wood grain.

What is claimed is:

1. A panel with a 3D texture structure, comprising at least a substrate, a pattern layer, a wear-resistant layer, and a topcoat layer from bottom to top; characterized in that the wear-resistant layer includes a thickness adjustment layer and a texture layer located above the thickness adjustment layer, the texture layer including a base portion and a three-dimensional portion, the three-dimensional portion being located above the base portion; the pattern layer contains a plurality of connected or unconnected wood grain-shaped lines, the three-dimensional portion includes a plurality of connected or unconnected wood grain-shaped grooves, at least some of the grooves corresponding to the lines in one or more of arrangement position, length, or width, and the top of at least part of the topcoat layer being lower than the upper surface of the three-dimensional portion.

2. The panel with a 3D texture structure according to claim 1, characterized in that the bottom and/or sidewalls of the grooves have a plurality of protrusions.

3. The panel with a 3D texture structure according to claim 1, characterized in that the number of protrusions on the bottom of at least some of the grooves exceeds the number of protrusions on the sidewalls, and/or the area of the protrusions on the bottom is greater than the area of the protrusions on the sidewalls.

4. The panel with a 3D texture structure according to claim 2, characterized in that the protrusions account for at least 1% of the total inner surface area of the grooves.

5. The panel with a 3D texture structure according to claim 2, characterized in that the sidewalls and the bottom of at least some of the grooves are connected at an obtuse angle.

6. The panel with a 3D texture structure according to claim 2, characterized in that the sidewalls have raised and/or recessed areas.

7. The panel with a 3D texture structure according to claim 1, characterized in that the three-dimensional portion is integrally connected to the base portion.

8. The panel with a 3D texture structure according to claim 1, characterized in that the maximum depth of the grooves is less than the thickness of the texture layer.

9. The panel with a 3D texture structure according to claim 1, characterized in that the thickness of the three-dimensional portion is greater than the thickness of the base portion.

10. The panel with a 3D texture structure according to claim 1, characterized in that the depth of the grooves is 0.03 mm to 0.20 mm.

11. The panel with a 3D texture structure according to claim 1, characterized in that at least some of the grooves include a central tactile enhancement portion, visual simulation portions at both ends, and a transition portion between the tactile enhancement portion and the visual simulation portions, with the width of at least some of the visual simulation portions being less than the width of the tactile enhancement portion.

12. The panel with a 3D texture structure according to claim 11, characterized in that the depth of the visual simulation portions of at least some of the grooves is less than the depth of the tactile enhancement portion.

13. The panel with a 3D texture structure according to claim 1, characterized in that the coating amount of the wear-resistant paint used for the thickness adjustment layer is 35 g/m² to 55 g/m².

14. The panel with a 3D texture structure according to claim 1, characterized in that the coating amount of the wear-resistant paint used for the texture layer is greater than or equal to 150 g/m².

15. The panel with a 3D texture structure according to claim 14, characterized in that the coating amount of the wear-resistant paint used for the base portion is greater than or equal to 75 g/m², and the coating amount of the wear-resistant paint used for the three-dimensional portion is greater than or equal to 75 g/m².

16. The panel with a 3D texture structure according to claim 1, characterized in that the panel further includes a color paint layer located between the substrate and the pattern layer.

17. The panel with a 3D texture structure according to claim 16, characterized in that the panel further includes a primer layer located between the substrate and the color paint layer.

18. The panel with a 3D texture structure according to claim 16, characterized in that the panel further includes a white film located between the substrate and the primer layer.

19. The panel with a 3D texture structure according to claim 16, characterized in that the color paint layer is white.

20. The panel with a 3D texture structure according to claim 1, characterized in that the topcoat layer includes two or more layers.
